(19) United States
(12) Patent Application Publication
(10) Pub. No.: US 2013/0192529 A1
(43) Pub. Date: Aug. 1, 2013

(54) Self-filling Bowl

(71) Applicants: Kevin M. Kruger, Eagle Point, OR (US); Mary L. Kruger, Eagle Point, OR (US)

(72) Inventors: Kevin M. Kruger, Eagle Point, OR (US); Mary L. Kruger, Eagle Point, OR (US)

(21) Appl. No.: 13/361,738

(22) Filed: Jan. 30, 2012

(51) Int. Cl. A01K 7/00; A01K 29/00

(52) U.S. Cl. 119/72

(57) ABSTRACT

A self-filling bowl formed in a supply reservoir is disclosed herein. The self-filling bowl may provide a sustainable water level in a drinking cavity during travel, even when the self-filling bowl is subjected to movement typical in common forms of travel, such as travel by an automobile, travel by commercial aircraft, and travel by a water vessel. The self-filling bowl may include an integrated reservoir, a base, and a drinking cavity at least partially formed within the reservoir. By integrating these components, the self-filling bowl may easily be transported between various locations. The drinking cavity may include at least two apertures that discharge liquid from the reservoir into the cavity to fill the cavity up to the upmost aperture.

### BACKGROUND

Conventional self-filling water receptacles often include a removable reservoir (e.g., bottle) and a separate base. The base allows attachment of the reservoir and discharges water from the reservoir into a cavity. By separating the reservoir from the base, the reservoir can be replaced or refilled without moving the base. However, these conventional self-filling water receptacles are not well-suited for movement or use in moving vehicles.

People often enjoy traveling with their animals, including horses, dogs, cats, birds, and/or other domesticated animals. Besides just trips to the veterinarian or local pet store, pets often accompany people during all types of travel including travel by land, by air, and over water. Like their human counterparts, pets also need to stay hydrated during travel and therefore need ready access to drinking water.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an isometric view of an illustrative self-filling bowl formed in a supply reservoir.

FIG. 2 is an isometric view of an illustrative self-filling bowl and lid.

FIG. 3 is a cross-sectional view of the illustrative self-filling bowl shown in FIG. 1.

FIG. 4 is a cross-sectional view of the illustrative self-filling bowl shown in FIG. 1 and including a recess for storing the lid.

FIG. 5 is a cross-sectional view of the illustrative self-filling bowl shown in FIG. 1 and including an illustrative plug.

FIG. 6 is a cross-sectional view of the illustrative self-filling bowl shown in FIG. 1 and including a removable portion to facilitate cleaning.

FIGS. 7A, 7B, and 7C are top views of illustrative self-filling bowls formed in a supply reservoir.

### DETAILED DESCRIPTION

A self-filling bowl formed in a supply reservoir is disclosed herein. The self-filling bowl may provide a sustainable water level in a drinking cavity during travel, even when the self-filling bowl is subjected to movement typical in common forms of travel, such as travel by an automobile, travel by commercial aircraft, and travel by a water vessel. The self-filling bowl may include an integrated reservoir, a base, and a drinking cavity at least partially formed within the reservoir. By integrating these components, the self-filling bowl may easily be transported between various locations. The drinking cavity may include at least two apertures that discharge liquid from the reservoir into the cavity to fill the cavity up to the upmost aperture.

The apparatuses described herein may be implemented in a number of ways. Example implementations are provided below with reference to the following figures.

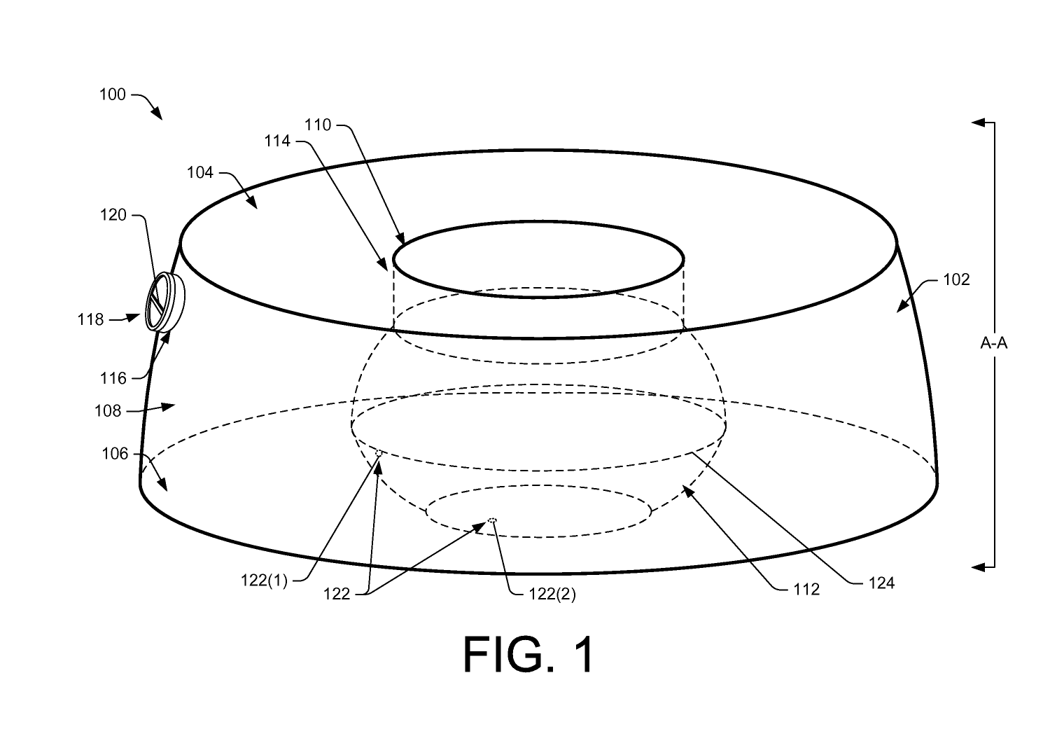

FIG. 1 is an isometric view of an illustrative self-filling bowl 100 formed in a supply reservoir 102. The reservoir 102 includes a top surface 104 and a bottom surface 106 opposite the top surface. The bottom surface 106 may act as a base to support the reservoir 102. The reservoir 102 also includes a wall structure 108 that extends between a perimeter of the top surface 104 and a perimeter of the bottom surface 106. The top surface 104, the bottom surface 106, and the wall structure 108 may be integrally formed and/or coupled to create a continuous shell that is capable of containing a liquid or fluid. In some embodiments, the reservoir 102 may be formed of a rigid and resilient material, such as plastic. The reservoir 102 may include an insulation layer on or integrated with the top surface 104, bottom surface 106, the wall structure, or a combination thereof, to help maintain a temperature of liquid inside the reservoir. The insulation layer may prevent or slow freezing of water when the reservoir is subjected to temperatures below freezing for a period of time (e.g., when the reservoir is in a car that is parked for a few hours during a shopping trip, etc.).

The top surface 104 includes an aperture 110 that provides access to a cavity 112 within the reservoir 102. The cavity 112 may include concentric walls having a concave shape as viewed from inside of the cavity. The top surface 104 may include a rim 114 that at least partially covers a portion of the cavity 112. The size of the aperture may be selected based on the type of animal that is expected to use the self-filling bowl. For example, when a horse or large breed dog is expected to use the bowl, a larger diameter may be selected for the aperture 110 as compared to when the bowl is expected to be used for a smaller animal, such as a small breed of dog, a cat, and so forth.

In accordance with various embodiments, the reservoir 102 is a container that can retain a liquid, such as water. The reservoir 102 may include a filling aperture 116 and plug 118 that enables filling of the reservoir with a liquid. The filling aperture may be located on any surface of the reservoir, such as the top surface 104, the bottom surface 106, or the wall structure 108. When the plug 118 is inserted into the filling aperture 116, the plug may seal the filling aperture 118 and thus prevent liquid within the reservoir to dispense out of the filling aperture. The plug 118 may be coupled with a gasket to create an airtight or liquid-tight seal. The plug 118 may couple with the reservoir 102 using threads or other types of connection means (snaps, friction, recessed lip, etc.). When coupled to the reservoir 102, the plug 118 may be flush or substantially flush with an exterior surface of the reservoir. The plug 118 may include a recessed feature 120 to enable removing the plug by twisting the plug and/or pulling the plug away from the reservoir. The recessed feature 120 may prevent an animal from chewing the plug or otherwise moving the plug. The plug 118 may also include a leash or tether that keeps the plug from being separated from the bowl and possibly lost or misplaced.

The cavity 112 may include apertures 122 which may be relatively small in size (e.g. less than a quarter inch in diameter, etc.). In various embodiments, the cavity may include at least two apertures. A first aperture 122(1) may be located at a fill line 124 within the cavity 112 while a second aperture 122(2) may be located at the fill line or below the fill line (closer toward the bottom surface 106). The apertures 122 allow the liquid within the reservoir 102 to discharge into the cavity 112 until the liquid reaches the fill line, which is defined by the location of the highest aperture of the apertures 122 (further away from the bottom surface 106). When the liquid in the cavity reaches the fill line, the apertures 122 become effectively sealed by the water, preventing airflow into the reservoir, which prevents additional liquid to fill into the cavity.

During a typical use of the self-watering bowl 100, a user may initially remove the plug 118 and fill the reservoir 102 with water. Once the reservoir 102 is full or substantially full of water, the user may replace the plug 118 to seal the filling aperture 116 (i.e., prevent airflow or liquid flow through the filling aperture 116). Next, the water within the reservoir 102 may dispense out of the reservoir through the apertures 122 until the water covers the apertures (reaches the fill line 124) and thereby seals the apertures 122 from further dispensing water. An animal, such as a horse, dog, cat, bird, rabbit, or other type of animal may then drink water from the cavity 112 through the aperture 110. When the water level drops below the fill level 124 (or one of the apertures is exposed to air, then the reservoir 102 may dispense additional water into the cavity 112. The reservoir 102 may also be made of a transparent or semi-transparent material and have gradient quantity indicator markings so a user can ascertain the amount of water used or remaining in reservoir.

By locating the cavity 112 within the reservoir 102, the self-watering bowl may effectively provide a self-filling supply of water for drinking by an animal. The location of the cavity 112 within the reservoir 102 may limit or prevent liquid in the cavity from spilling or splashing outside of the cavity 112 or the aperture 110 during movement of the self-filling bowl, such as when the self-filling bowl is used in a moving vehicle, aircraft, or water vessel (e.g., a boat, a ship, etc.) or when in use by an animal.

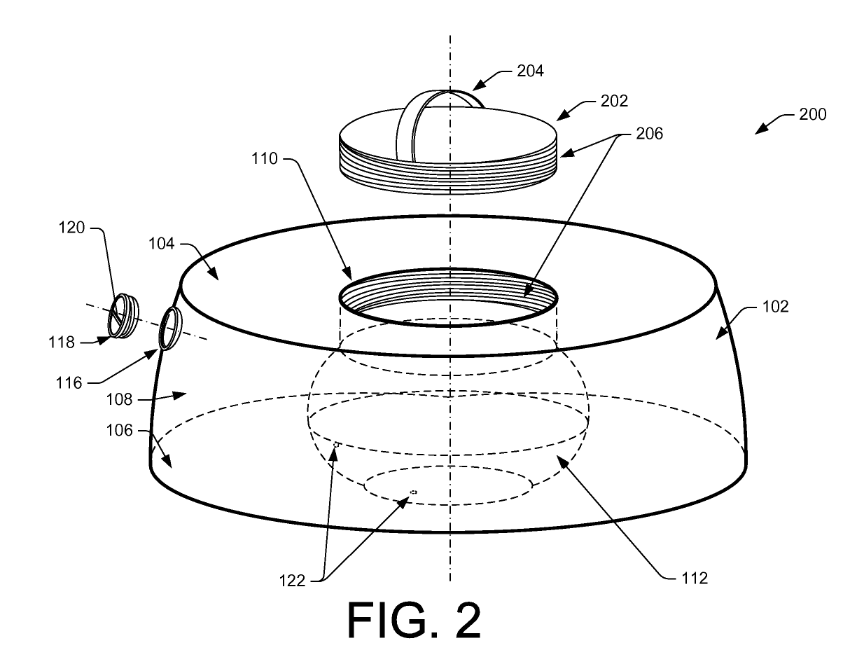

FIG. 2 is an isometric view of an illustrative self-filling bowl and lid assembly 200. The assembly 200 includes an exploded view showing a lid 202 that is configured for removable coupling to the reservoir 102 to seal the cavity 112. The assembly 200 also shows an exploded view of the plug 118 that is configured for removable coupling to the reservoir to seal the filling aperture 116.

The lid 202 may include a handle 204. The handle may be grasped by a user to assist with attachment of the lid 202 to the reservoir 102 by a coupling means 206, such as by threads, snaps, slots, or other coupling mechanisms. The handle may also be used to carry the reservoir 102 when the lid 202 is coupled to the reservoir. The lid 202 and/or the reservoir 102 may include a gasket, which may be situated between at least a portion of the lid and the reservoir when coupled together to seal the cavity and prevent liquid within the cavity from dispensing outside of the cavity (other than into the reservoir via the apertures 122.

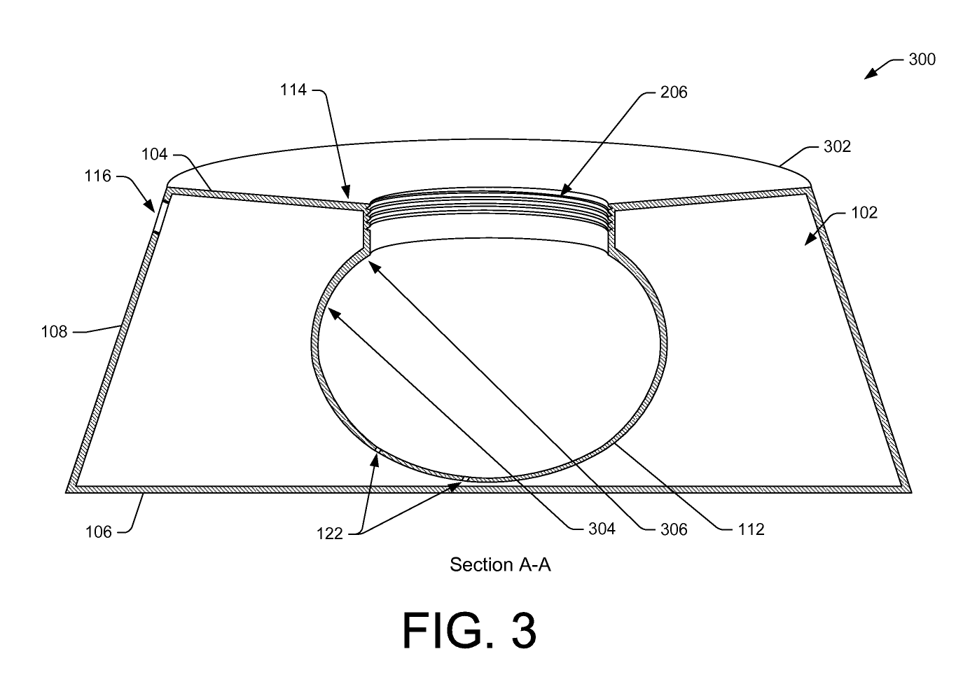

FIG. 3 is a cross-sectional view of a section A-A 300 of the illustrative self-filling bowl shown in FIG. 1. The section A-A 300 shows the coupling means 206 that allows removable coupling of the lid 202 to the reservoir 102.

The section A-A 300 shows the filling aperture 116 and the apertures 122. Although the filling aperture 116 and the apertures 122 are shown as being bisected by the sectional cut A-A, the filling aperture 116 and/or the apertures 122 may be located in other portions of the reservoir 102 or cavity 112, respectively, in accordance with some embodiments.

The top surface 104 may be slanted downward from the top of the wall structure 108 toward the rim 114 to enable recapture of liquid that may be caught on the top surface (e.g., drool of a pet, splash from liquid inside the cavity, etc.). In some embodiments, the top surface 104 may be conically shaped or concave, whereby the rim 104 is located closer to the bottom surface 106 than a perimeter of the top surface 302.

As discussed with reference to FIG. 1, the cavity 112 may include one or more concave walls having a concave shape 304 as viewed from inside of the cavity. The concave shape 304 may at least partially prevent liquid within the cavity 112 from splashing outside of the cavity. For example, a lower side 306 of the rim 114 may include a planar surface that may be substantially parallel with the bottom surface 106. Thus, when liquid splashes up a side of the cavity, such as after the reservoir 102 is quickly moved in a lateral direction, the splashing liquid may be at least partially recaptured within the cavity. The lower side 306 may also include a lip, groove, protrusion, or other feature to enhance recapture of the splashing liquid.

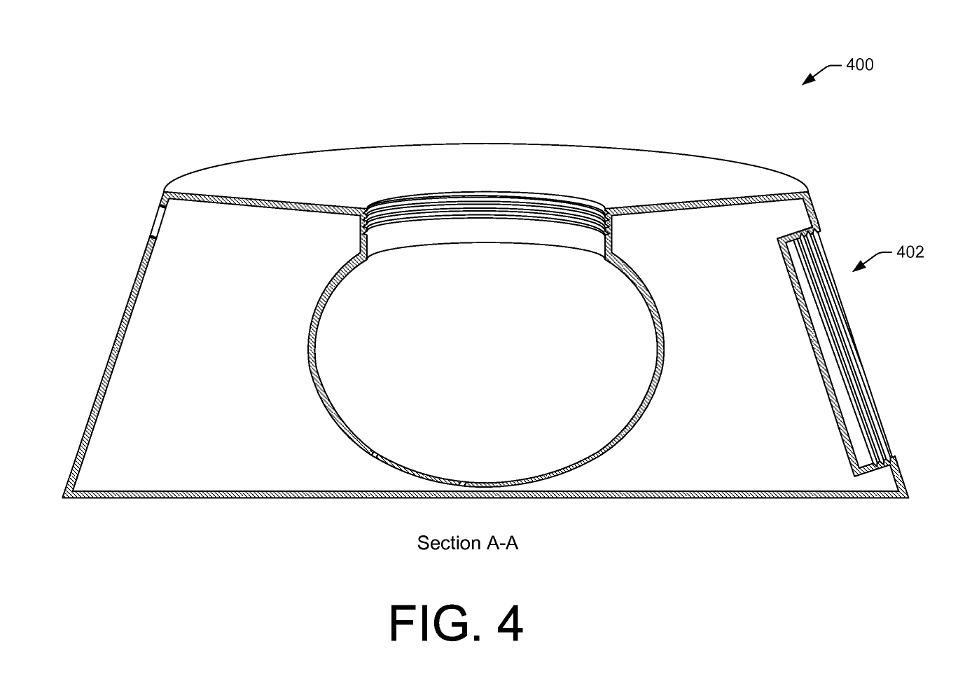

FIG. 4 is a cross-sectional view of a section A-A 400 of the illustrative self-filling bowl shown in FIG. 1 and includes a storage recess 402 for storing the lid 202, shown in FIG. 2. The lid 202 may be stored in the storage recess 402 when the self-filling bowl is in use or available for use by a pet or other animal The handle 204 of the lid 202 may be formed of a resilient material to prevent destruction of the handle caused by chewing by an animal when the lid is stored in the storage recess 402. In some embodiments, the handle may be recessed in the lid and/or made of a flexible medium (e.g., nylon) and possibly recess within the lid. When the lid 202 is stored in the storage recess 402, the lid may be flush or substantially flush with an exterior surface of the reservoir 102.

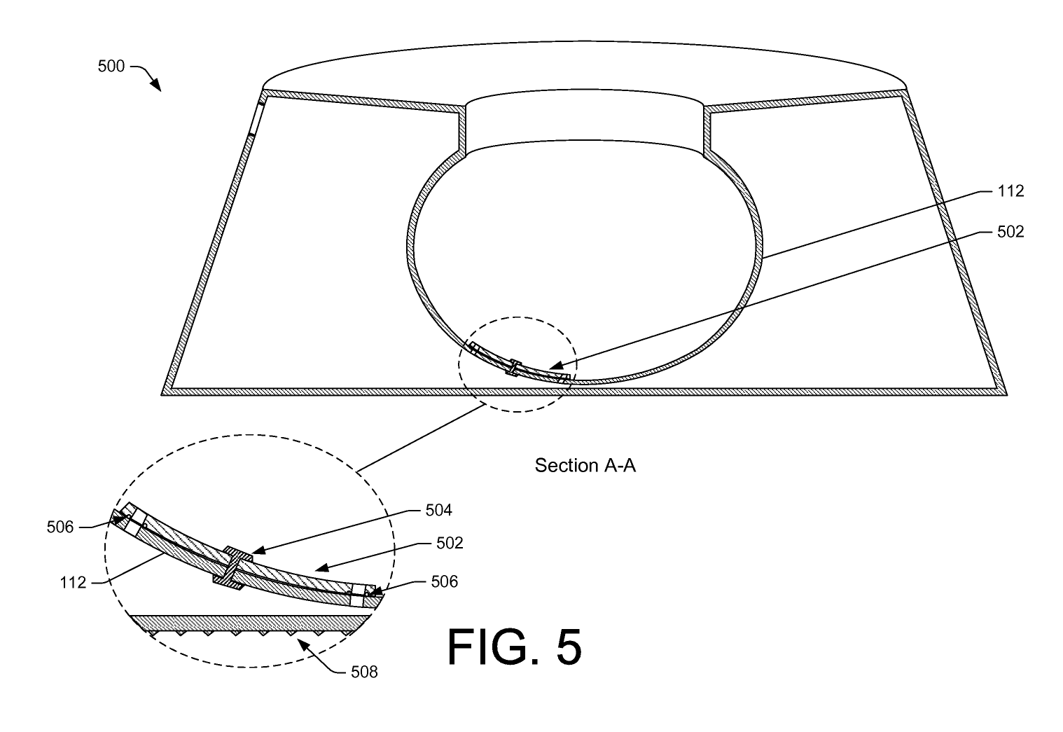

FIG. 5 is a cross-sectional view of a section A-A 500 of the illustrative self-filling bowl shown in FIG. 1 and includes an illustrative aperture plug 502. The aperture plug 502 may selectively seal the reservoir 102 and thereby contain the liquid within the reservoir when any other aperture in the reservoir is also sealed, such as the filling aperture 116 sealed by the plug 118. The aperture plug 502 may be movable from a first position that allows airflow (and liquid flow) through the apertures 122 and the aperture plug and a second position where the aperture plug prevents airflow (and liquid flow) through the apertures 122. In some embodiments, the aperture plug 502 may be a rotatable plug that rotates on a pivot 504 or a slidable plug that slides on a track. The aperture plug 502 may include gaskets 506 to prevent leakage of liquid or air through the apertures 122. The aperture plug may rotate or slide from the first position to the second position to either permit or prevent airflow (and liquid flow) through the apertures 122. In some embodiments, the aperture plug 502 may move from the first position to the second position using other mechanism such as an insertable stopper, or other mechanisms that seal the apertures 122.

In some embodiments, the aperture plug 502 may effectively seal the aperture 122 and thereby negate any need to otherwise close the cavity 112 when the bowl is not in use. A user can simply use the aperture plug 502 to seal the apertures (and thus the reservoir 102), and then transport the reservoir in any orientation without worrying about spilling or dispensing liquid from the reservoir 102. The aperture plug 502 may also allow a user to fill the reservoir 102 with liquid without dispensing liquid through the apertures 122, which may allow the user to more completely fill the volume within the reservoir with liquid when the apertures a sealed (closed, obstructed) by the aperture plug 502.

In accordance with various embodiments, the bottom surface 106 may include outward facing (away from the top surface 104) friction features 508. For example, the outward facing friction features may be spikes, extrusions, tread, or pointed features that provide resistance to a carpeted or otherwise porous surface and thereby prevent or inhibit lateral movement of the reservoir 102.

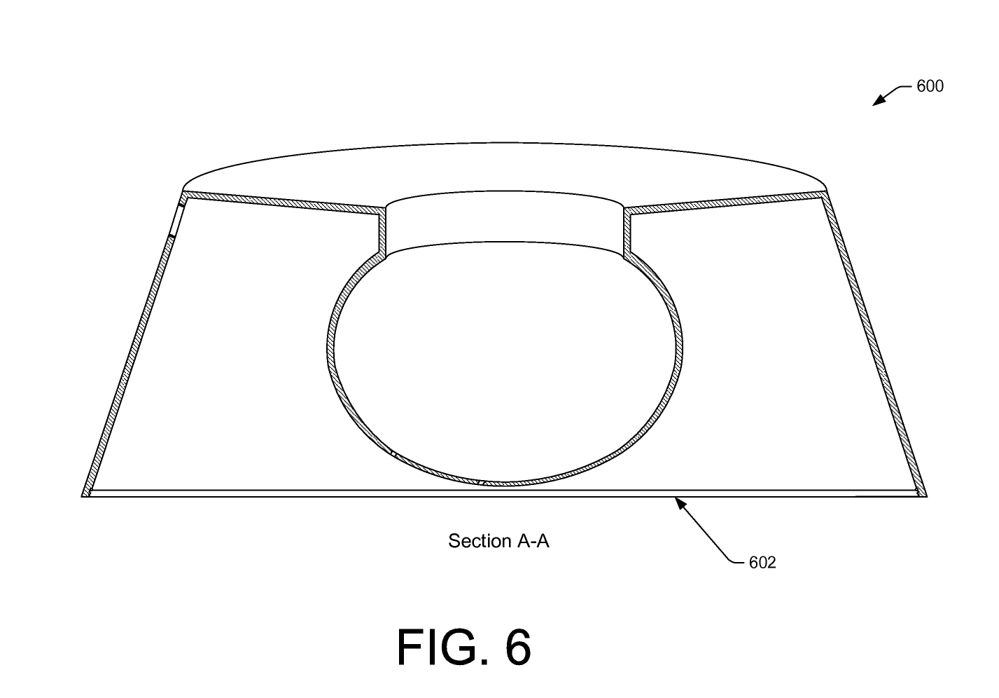

FIG. 6 is a cross-sectional view of a section A-A 600 of the illustrative self-filling bowl shown in FIG. 1 and includes a removable portion 602 to facilitate cleaning inside of the reservoir 102. The removable portion 602 may removably couple to the bottom surface 106, the wall structure 108, or the top surface 104. The removable portion 602 may couple to the reservoir 102 by threads, snaps, or other coupling means.

In some embodiments, the removable portion 602 may span the top surface 104 and the wall structure 108 or the bottom structure 106 and the wall structure to enable disassembly of the reservoir 102 and access to the interior of the reservoir for cleaning purposes or other reasons. In this way, the removable portion 602 may be an upper section or a lower section of the reservoir 102 that mates with the complementary other section of the reservoir, when assembled.

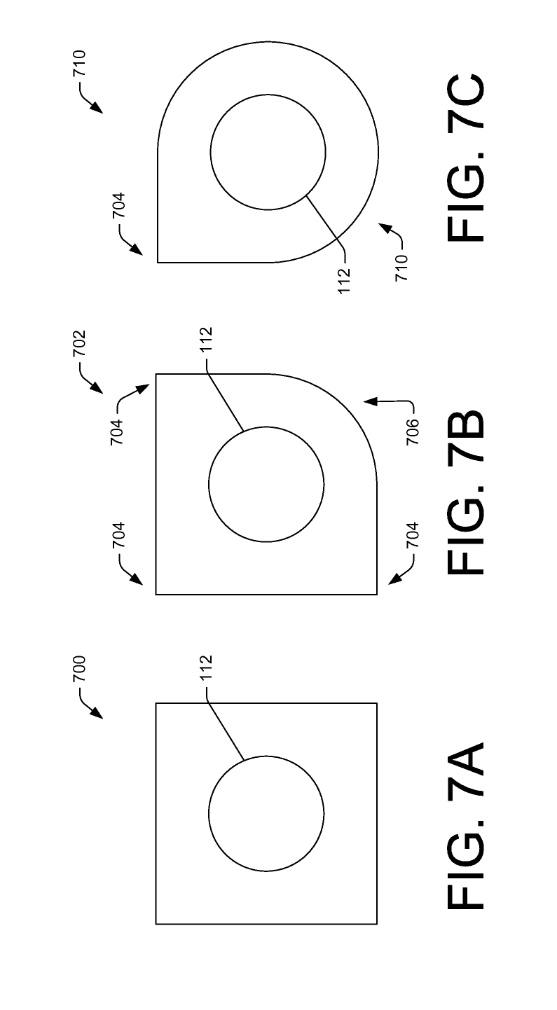

FIGS. 7A, 7B, and 7C are top views of illustrative self-filling bowls formed in a supply reservoir. FIG. 7A shows a reservoir 700 having a square or rectangular shape. FIG. 7B shows the reservoir 702 having three corners 704 each having a ninety degree angle (however other angles may be used) and one rounded corner 706. FIG. 7C shows a reservoir 708 having one corner 704 having a ninety degree angle (or other angle) and a rounded section 710 formed by the wall structure 108. The reservoirs 700, 702, and 708 may enable compact placement of the reservoir in a corner space, such as in a bird cage, a dog crate, a horse trailer, a cat crate, or another animal shelter.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An apparatus comprising:
a reservoir having a volume to contain a liquid, the reservoir having a top surface opposite a bottom surface and a continuous exterior wall joining the top surface to the bottom surface, the top surface including a recess that forms a cavity that extends toward the bottom surface, the cavity including at least two apertures that discharge liquid from the reservoir to fill a portion of the cavity below the upmost aperture and thereby maintain a constant level of the liquid in the cavity while the reservoir is filled with the liquid.

2. The apparatus as recited in claim 1, wherein the top surface is an angled surface that angles downward from an outer rim adjacent to the exterior wall structure and toward a perimeter of the cavity, the angled surface to recapture liquid from the top surface into the cavity.

3. The apparatus as recited in claim 1, further comprising a lid that securely couples to the reservoir to seal the cavity and prevent discharge of the liquid from the cavity while the lid is coupled to the reservoir.

4. The apparatus as recited in claim 3, wherein the reservoir includes a storage location for the lid, the storage location being integrally formed on an exterior of the reservoir.

5. The apparatus as recited in claim 1, further comprising a plug to seal the at least two apertures.

6. The apparatus as recited in claim 5, wherein the plug comprises a rotatable surface having apertures that align with the at least two apertures when the plug is in a first position and seal the at least two apertures when the plug is a second position.

7. The apparatus as recited in claim 1, wherein the cavity includes a concave wall above the upmost aperture and toward the top surface, the concave wall having a concave shape as viewed from inside of the cavity, the concave shape to at least partially prevent liquid within the cavity from splashing outside of the cavity when the reservoir is subjected to lateral movement.

8. The apparatus as recited in claim 1, wherein the bottom surface includes outward facing friction features.

9. The apparatus as recited in claim 1, wherein the reservoir includes a filling aperture that provides access to an interior of the reservoir, and further comprising a plug that removably couples to the reservoir to seal the filling aperture, the plug being substantially flush with an exterior of the reservoir when coupled to the reservoir.

10. A reservoir comprising:
a exterior bowl shaped portion that includes a base and a exterior wall structure extending upward from a perimeter of the base; and
an interior bowl shaped portion the includes a base and a interior walled structure extending upward from the perimeter of the base to form a cavity, the interior bowl shaped portion further including a top surface coupled to the interior walled structure and spanning outward from the top of the cavity, the interior bowl shaped portion being coupled to the exterior bowl shaped portion by coupling the top surface to the exterior wall structure to define a volume to store liquid, the cavity including at least two apertures that allow liquid in the volume to dispense into the cavity and thereby maintain a constant level of the liquid in the cavity while the volume is filled with the liquid.

11. The reservoir as recited in claim 10, wherein the top surface angles downward from the exterior wall structure toward an edge of the cavity, the angled surface to recapture liquid from the top surface into the cavity.

12. The reservoir as recited in claim 9, further comprising a lid that removably couples to the interior bowl shaped portion to seal the cavity and prevent discharge of the liquid within the cavity while the lid is coupled to the interior bowl shaped portion.

13. The reservoir as recited in claim 12, wherein the reservoir includes a storage location for the lid, the storage location being integrally formed on an exterior of the reservoir.

14. The reservoir as recited in claim 10, further comprising a plug to seal the at least two apertures.

15. The reservoir as recited in claim 14, wherein the plug comprises a rotatable surface or a sliding surface having apertures that align with the at least two apertures when the plug is in a first position and seal the at least two apertures when the plug is a second position.

16. The reservoir as recited in claim 10, wherein at least a portion of the exterior bowl shaped portion is removable to enable access to the interior of the reservoir.

17. A self-filling bowl comprising:
a reservoir having a volume to store a liquid, the reservoir having a top surface including a recess that forms a cavity that extends away from the top surface and toward a bottom surface of the reservoir, the cavity including at least two apertures that allow liquid within the reservoir to discharge from the reservoir and fill a portion of the cavity below the upmost aperture and thereby maintain a constant level of the liquid while the reservoir stores the liquid.

18. The self-filling bowl as recited in claim 17, further comprising a lid that securely couples to the reservoir to seal the cavity and prevent discharge of the liquid from the cavity while the lid is coupled to the reservoir.

19. The self-filling bowl as recited in claim 17, further comprising a plug to seal the at least two apertures.

20. The self-filling bowl as recited in claim 19, wherein the plug comprises a rotatable surface or a sliding surface having apertures that align with the at least two apertures when the plug is in a first position and cover the at least two apertures when the plug is a second position.
